(19) United States
(12) Patent Application Publication
(10) Pub. No.: US 2013/0238401 A1
(43) Pub. Date: Sep. 12, 2013

(54) SYSTEM AND METHOD FOR ADVERTISING AND SELLING OF A VENTURE PROJECT VIA COMPETITIVE CAPITAL RAISING

(71) Applicants: Andrew H B Zhou, Tiburon, CA (US); Tiger T G Zhou, Tiburon, CA (US); Dylan T X Zhou, San Gabriel, CA (US)

(72) Inventors: Andrew H B Zhou, Tiburon, CA (US); Tiger T G Zhou, Tiburon, CA (US); Dylan T X Zhou, San Gabriel, CA (US)

(21) Appl. No.: 13/868,405

(22) Filed: Apr. 23, 2013

Related U.S. Application Data
(63) Continuation-in-part of application No. 13/287,279, filed on Nov. 2, 2011.

(51) Int. Cl. G06Q 30/02

(52) U.S. Cl. CPC G06Q 30/0279
USPC 705/7.38

(57) ABSTRACT

Provided is a system for competitive investment raising for a venture project. The system may include a memory to store data on a number of venture projects, and a processor communicatively coupled to the memory. The processor may be configured to receive the data on the number of venture projects, and assign one or more of the number of venture projects to a venture capitalist. The venture project assigned to the venture capitalist may be an assigned venture project. The processor may be also configured to provide a pre-investment amount to the assigned venture project; periodically receive a progress report from a representative of the assigned venture project; periodically receive an evaluation of the assigned venture project; based on the evaluation, periodically determine failed venture projects that drop out of the competitive investment raising; and determine a winning venture project. The winning venture project may receive an investment amount.

### CROSS-REFERENCE TO RELATED APPLICATIONS

This application is a continuation-in-part of U.S. patent application Ser. No. 13/287,279, entitled “METHODS AND SYSTEMS TO ADVERTISE AND SELL PRODUCTS OR SERVICES VIA CLOUD GAMING ENVIRONMENTS,” filed on Nov. 2, 2011, which is incorporated herein by reference in its entirety.

### FIELD

The application relates generally to methods and systems of raising capital and, more specifically, to methods and systems for advertising and selling of a venture project via competitive capital raising.

### BACKGROUND

Venture projects often require large investment while the risks may be high. Investors desire to mitigate the risks associated with investment in venture projects and increase the probability of a good return. Moreover, the process and criteria of selecting a venture project for investing can be time consuming and involve subjective assessment.

Furthermore, venture projects and their products can require costly advertising and promoting that nevertheless does not guarantee attracting the audience. Thus, an improved and more objective process of investing in venture projects and advertising venture projects is desirable.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are novel systems and methods for competitive investment raising for a venture project. In some embodiments, the method for competitive investment raising for a venture project may include receiving data on a number of venture projects and assigning one or more of the number of venture projects to a venture capitalist. The venture project assigned to the venture capitalist may be considered the assigned venture project. Assigning venture projects may be based on a choice of a venture capitalist, random choice, or other methods. The assigned venture projects may be provided with a pre-investment amount. Then, a representative of the assigned venture project may periodically provide a progress report related to the assigned venture project. In addition to that, an evaluation of the assigned venture project may be periodically received. Based on the evaluation, failed venture projects may be periodically selected, a failed venture project dropping out of the competitive investment raising. As a result of the selection, a winning venture project may be determined. The winning venture project may receive an investment amount.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing a sample environment within which a system and method for competitive investment raising for a venture project are implemented, in accordance with an example embodiment.

FIG. 2 is a flow chart illustrating a method for competitive investment raising for a venture project, in accordance with an example embodiment.

FIG. 3 is a block diagram illustrating a sample preselecting of venture projects, in accordance with an example embodiment.

FIG. 4 is a block diagram illustrating a sample assigning of preselected venture projects to venture capitalists, in accordance with an example embodiment.

FIG. 5 is a block diagram illustrating a sample selection of assigned venture projects, in accordance with one embodiment.

FIG. 6 is a block diagram illustrating a sample comparison of assigned venture projects during a selection, in accordance with one embodiment.

FIG. 7 is a diagrammatic representation of an example machine in the form of a computer system within which a set of instructions for causing the machine to perform any one or more of the methodologies discussed herein is executed.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

Systems and methods described herein may allow determining venture projects for investing with mitigated risks. The process of determining a venture project for investing may be made publicly available to attract public attention and involve public in the decision process. To achieve this, one or more stages of determining a venture project for investing may be demonstrated on television in the form of a television show, reality show, and so forth. Additionally, one or more stages of determining a venture project for investing may be made available online, for example, through a web resource.

An organizer of competitive investment raising for a venture project may preselect a number of venture project from a pool of venture projects. The pool of venture projects may include data on venture projects received from representatives of venture projects (for example, a head or an executive of a venture project). In some embodiments, the pre-selection may be based at least in part on public votes provided by means of an online voting, SMS voting (Short Message Service), and so forth.

Data on the preselected venture projects may be provided to venture capitalists, each of which may select a predetermined number of venture projects to be assigned to him. The venture capitalist may mentor, supervise, consult, advice, and provide other support to venture projects assigned to him. The assigned venture project may receive a pre-investment amount to perform a detailed analysis, carry out establishment procedures, and/or perform other preparatory actions. After a predetermined time period after receiving the pre-investment amount, the representative of each of the assigned venture projects may provide a progress report for his venture project. The progress report may include a personal presentation, a financial report, a research report, and so forth.

Additionally, an evaluation may be received for each of the assigned venture projects. The evaluation may include various components. For example, the venture capitalist may provide his opinion for each of the venture projects assigned to him. An expert, such as a certified public accountant, financial adviser, investment adviser, and so forth, may provide an expert opinion in relation to the assigned venture projects. In some embodiments, public votes and/or media votes may also be received for assigned venture projects. The evaluation of each assigned venture projects may be analyzed to compare the assigned venture projects in terms of their progress. Based on the evaluation, some of the assigned venture projects may be selected to continue participation in the competitive investment raising.

The progress reports and/or evaluation may be periodically received and the assigned venture projects may be periodically selected until only one venture project is left. The left venture project may be determined as a winning venture project. The winning venture project may receive an investment amount.

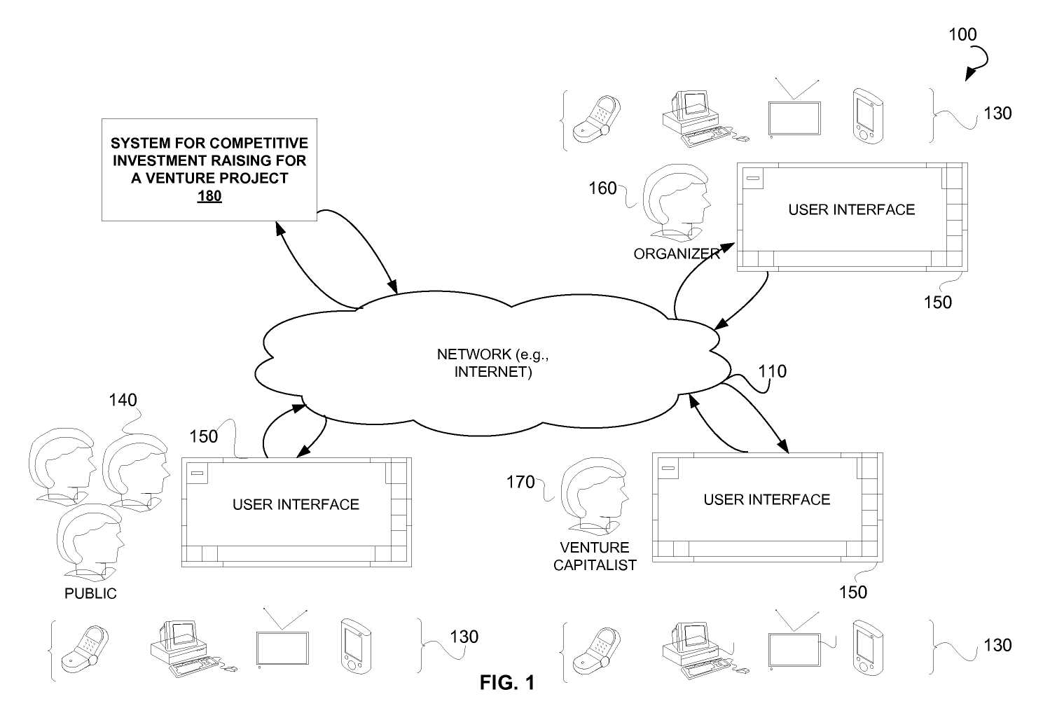

Referring now to the drawings, FIG. 1 is a block diagram showing a sample environment within which a system and method for competitive investment raising for a venture project are implemented, according to an example embodiment.

As shown in FIG. 1, an example architecture 100 may include a network 110, a user interface 150, client devices 130, public 140, an organizer 160, a venture capitalist 170, and a system for competitive investment raising for a venture project 180. The venture capitalist 170 may be a professional investor, a fund manager, an investment advisor, and so forth. The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may be a network of data processing nodes that are interconnected for the purpose of data communication.

The client devices 130, in some example embodiments, may include a Graphical User Interface (GUI) for displaying the user interface 150. In a typical GUI, instead of offering only text menus or requiring typed commands, the system presents graphical icons, visual indicators, or special graphical elements called widgets that may be utilized to allow users to interact with the user interface 150. The client devices 130 may be configured to utilize icons used in conjunction with text, labels, or text navigation to fully represent the information and actions available to users.

The client devices 130 may include a personal data assistant, desktop computer, laptop computer, cell phone, smart phone, gaming device or the like. The public 140, the organizer 160, or the venture capitalist 170, in some example embodiments, is a person interacting with the user interface 150 via the client devices 130. The public 140, the organizer 160, or the venture capitalist 170 may be a user of the system for competitive investment raising for a venture project 180.

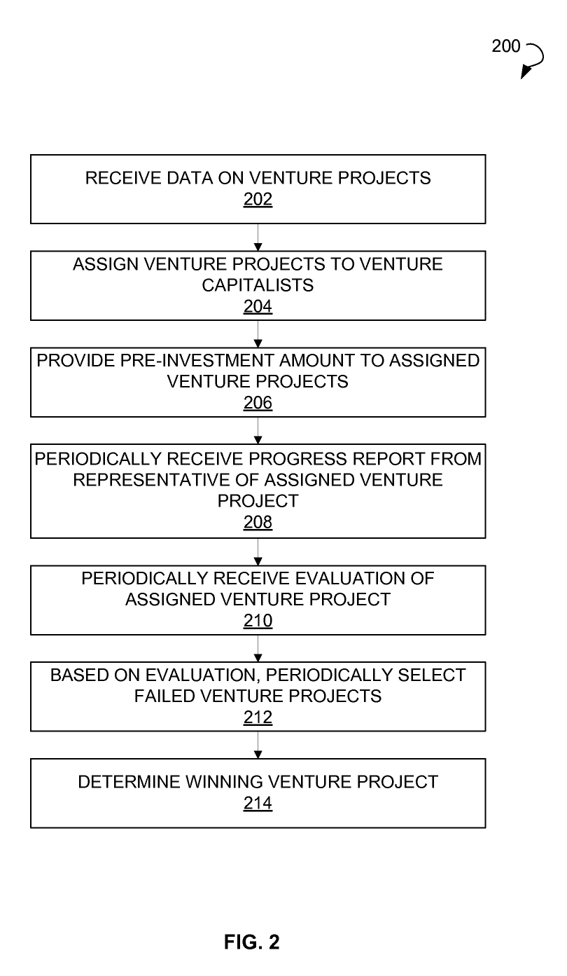

FIG. 2 is a process flow diagram illustrating a sample method 200 for competitive investment raising for a venture project, in accordance with an example embodiment.

The method 200 may commence with receiving data on venture projects at operation 202. The data may be received through online resources or other lines of communication, including mail (electronic or not), fax, telephone, and so forth. The venture projects, on which the data is received, may be preselected by an organizer of the competitive investment raising for a venture project, preselected automatically, based on public and/or media votes, a combination of both, or any other method.

The method 200 may continue with assigning the venture projects to venture capitalists at operation 204. Each of the venture capitalists may be assigned a predetermined number of venture projects. Assigning venture projects to venture capitalists may be based on a choice of a venture capitalist, random choice, and so forth.

The venture projects not assigned to any venture capitalist may drop out of the competitive investment.

At operation 206, a pre-investment amount may be provided to each of the venture projects assigned to a venture capitalist. The pre-investment amount may be provided to the assigned venture project to finance preparatory actions to start business of the venture project. The venture capitalist, to which the venture project is assigned, may mentor, consult, advise, supervise, and provide other assistance to the assigned venture projects. In some embodiments, a specific time period may be set for preparatory actions.

At operation 208, a progress report may be periodically received from a representative of the venture project (for example, an executive). The progress report may describe the progress achieved by the venture project during the elapsed time period. The progress report may include a personal presentation of the representative, reports, surveys, and other materials.

At operation 210, an evaluation of the assigned venture project may be periodically received. The evaluation may include an expert opinion, an opinion of a venture capitalist, public votes, media votes, and so forth. Each component of evaluation (i.e. an expert opinion, an opinion of a venture capitalist, votes) may have certain weight or constitute a predetermined percent of the evaluation.

Based on the evaluation, failed venture projects may be periodically selected at operation 212. For example, assigned venture projects of each venture capitalist may be divided into pairs and the evaluations of the venture projects in each pair can be compared. Based on the comparison, one of each pair of the venture projects may be considered failed and drop out of the competitive investment raising.

Operations 208-212 may periodically repeat, thus reducing the number of the assigned venture projects, until only one venture project is left. Such venture project may be determined as a winning venture project at operation 214. The winning venture project may receive an investment amount. The investment amount may be provided, partially or fully, by public, media, a venture capitalist, and so forth.

In some embodiments, the winning venture project may provide a return to one or more of the venture capitalists and/or other parties involved in the investment.

In some embodiments, one or more operations of the method 200 may be performed and/or demonstrated online through an online resource, web-based system, and so forth. Various data and content associated with the method 200 may be provided online, and public may provide feedback, vote, or otherwise interact with such online resource, web-based system, and so forth.

In some embodiments, one or more operations of the method 200 may be performed and/or demonstrated by television as a television show, reality show, and so forth. Public may provide feedback, vote, or otherwise interact with competitive investment raising process through a telephone, short message services, online resources, mail, and so forth.

In some example embodiments, at various stages of the competitive investment raising, the method 200 may optionally comprise displaying a third party advertisement (not shown). The third party advertisement may be associated with the one or more of the following: a venture project, an assigned venture project, or a winning venture project.

The third party advertisement may be associated with products or services provided by a third party and carry some form of identification of these products or services or a party that provides these products and services. For example, advertisement objects may include trademarks of the brand owners and/or description of the product or services. It may include various forms of multimedia, such as text, video, audio, animation, image, flash, and pop up.

Objects corresponding to the third party advertisement may be positioned within the content related to venture projects such that public can view these advertisement objects and, in certain embodiments, interact with these advertisement objects. Some examples of advertisement objects include banners and pop-up screens. For example, pop-up screens may be used to provide a challenge for users while they are viewing content related to the venture projects.

In the same or other embodiments, the third party advertisement may be presented on a timed screen displayed in the competitive investment environment in between two portions of content, before or after the content demonstration. For example, the content may include some waiting periods, such as pauses or commercial breaks. During such periods, the user may be presented with the third party advertisement, which may be in the static, dynamic, and/or interactive forms as explained above. One such period may be during content loading. Another such period may be before announcing the winning venture project. Further, the content demonstration may be periodically stopped for displaying the third party advertisement. During these periods, the users may still focus on the screen because the content demonstration may commence at any moment, i.e., duration of the third party advertisement display may be unknown to the users and the content demonstration may restart after some longer periods in some instances and some shorter periods in other instances.

The winning venture project may receive the investment amount. However, a predetermined commission may be extracted from the investment amount of the winning venture project.

When a failed venture project is determined, funds associated with the failed venture project may be returned after deduction of a predefined amount associated with bidding process.

Additionally, the method 200 may optionally include identifying an interaction level of users with the third party advertisement (not shown). The interaction level may be identified while users interact with an online resource for the competitive investment raising. Based on the identification, a fee payable by a third party may be determined.

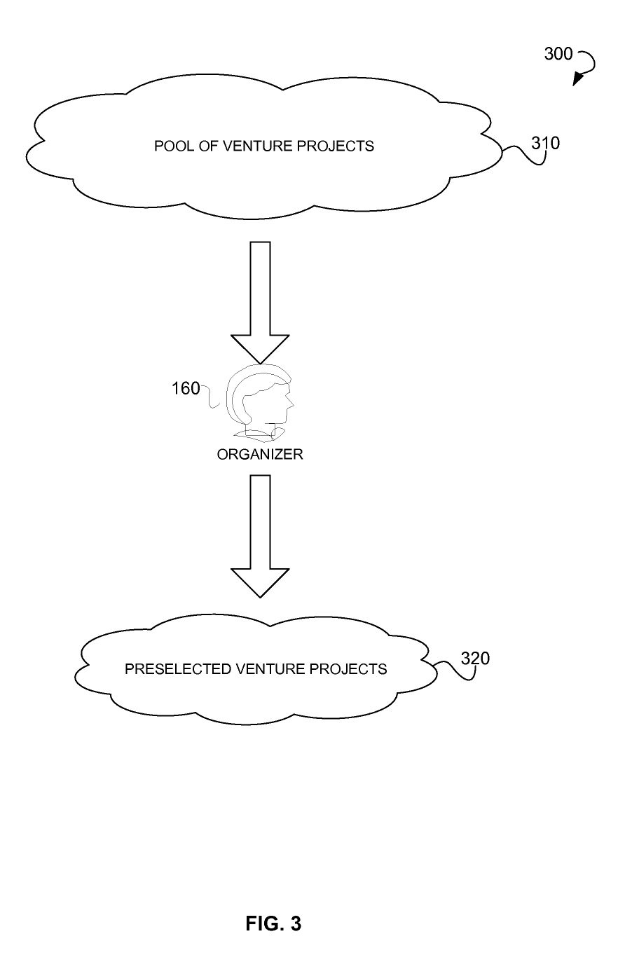

FIG. 3 is a block diagram illustrating a sample preselecting 300 of venture projects, in accordance with an example embodiment. A pool of venture projects 310 may include venture projects data on which are received from representatives of venture projects through various communication means. For example, the data on venture projects may be received though an online resource associated with the system for competitive investment raising for a venture project, mail, fax, telephone, and so forth. The data on venture projects may include any information related to a venture project. For example, graphical information, text information, audio information, and so forth.

The organizer 160 of the competitive investment may preselect venture projects from the pool of venture projects 310 for participation in competitive investment raising. In some embodiments, preselection may be based partially or fully on expert opinions, public or media votes, and so forth.

The venture projects preselected for participation in competitive investment raising may constitute preselected venture projects 320. The preselected venture projects may be accepted for continuing participation in the competitive investment raising process.

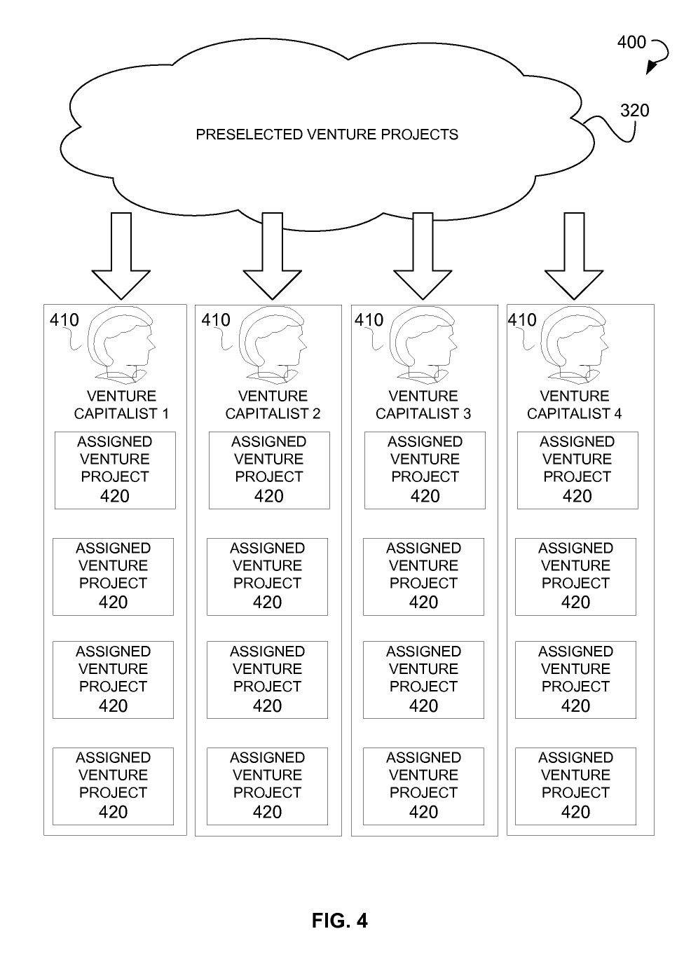

FIG. 4 is a block diagram, illustrating a sample assigning 400 of preselected venture projects 320 to venture capitalists 410. A predetermined number of venture projects from the preselected venture projects 320 may be assigned to each of the venture capitalists 410. Assigning to the venture capitalist 410 may be based on a choice of the venture capitalist 410, random choice, or another method. An assigned venture project 420 may be approved for further participation in competitive investment. In some embodiments, the assigned venture project 420 may receive a pre-investment amount to start business. The venture capitalist 410 may assist the venture projects 420 assigned to him in starting business and performing preparatory actions. For example, the venture capitalist may mentor, consult, or advice the assigned venture projects 420 associated with him. The assigned venture projects 420 may be periodically compared to select some of them to continue participation in competitive investment.

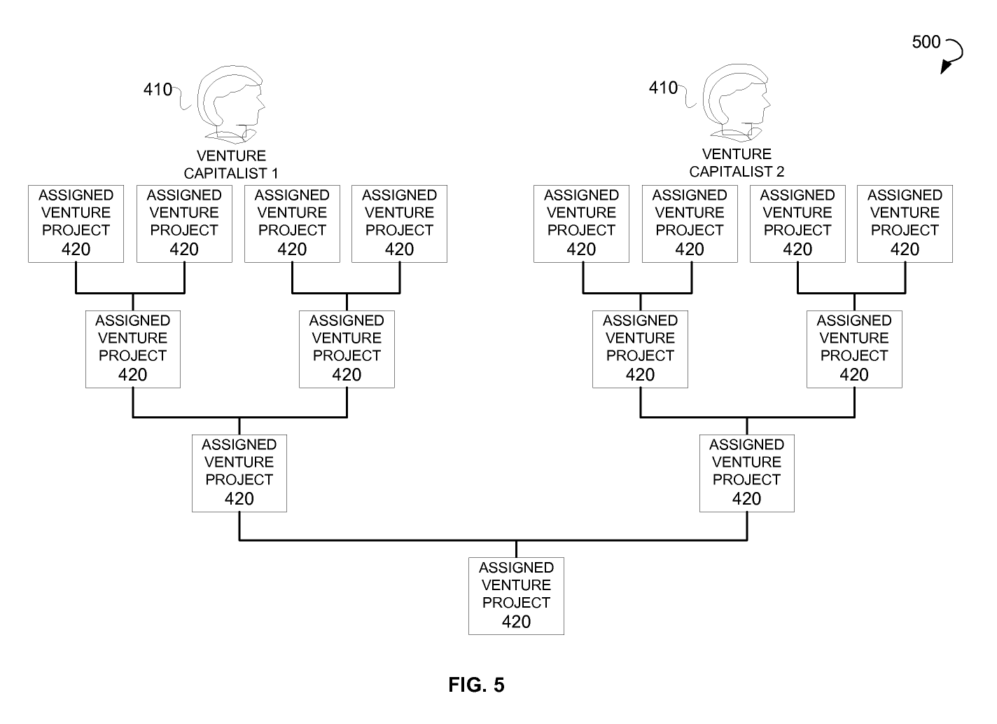

FIG. 5 is a block diagram, illustrating a sample selection 500 of assigned venture projects 420, in accordance with one embodiment. The assigned venture projects 420 associated with the same venture capitalist 420 may be periodically split into pairs. The assigned venture projects 420 from each pair may be compared to each other based on evaluation. In the result of the comparison, one assigned venture project 420 of a pair may be considered failed and drop out of the competitive investment raising, whereas the other assigned investment project may stay in the competition. Thus, the number of the assigned venture projects 420 may be periodically reduced until there is only one venture project 420 assigned to the venture capitalist 410.

Then, the assigned venture projects 420 associated with different venture capitalists 420 may be periodically split into pairs and compared. The selection process may stop when there is only one assigned venture project 420 left for all venture capitalists 410.

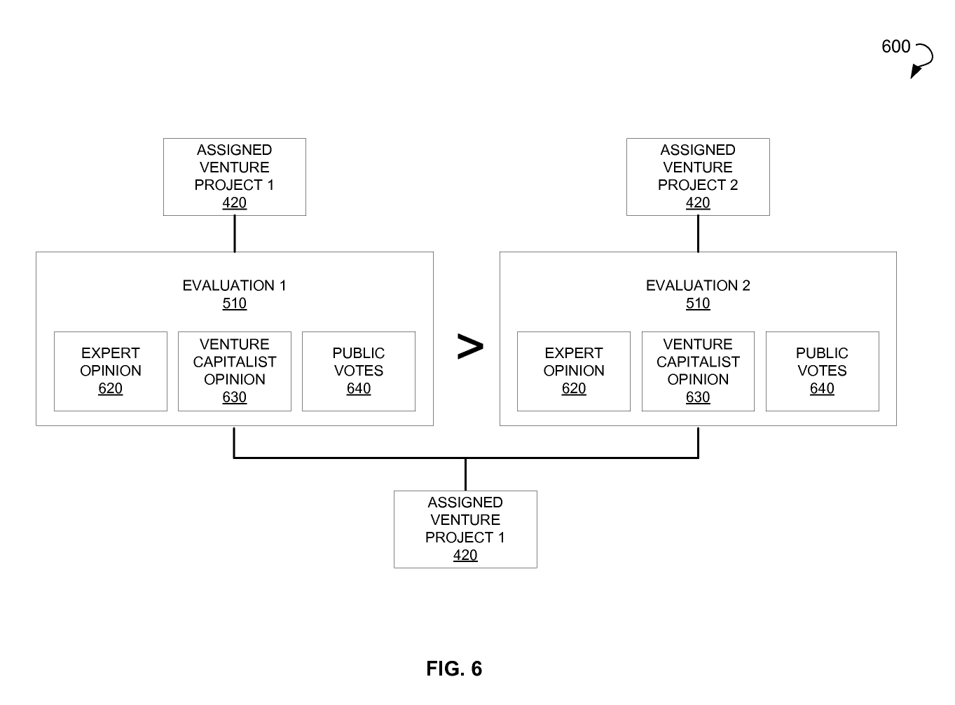

The comparison of the assigned venture projects 420 is illustrated by FIG. 6. FIG. 6 is a block diagram illustrating a sample comparison 600 of assigned venture projects 420 during a selection, in accordance with one embodiment.

Periodically, a progress report may be received for the assigned venture project 420. The progress report may be made available to the venture capitalists 410, experts, media, and/or public. Then, evaluation 510 of the assigned venture project 420 may be received, the evaluation 510 including an expert opinion 620, venture capitalist opinion 630, public votes 640, and so forth.

In some embodiments, the evaluation 510 may include media votes. The media votes may include votes of media representatives involved in the competitive investment raising in any manner, data provided by media of any type (for example, by a newspaper, a magazine, an online media resource, a television channel, a radio channel), and so forth.

In some embodiments, the components included in the evaluation 510 may be analyzed to receive a numeric value for comparison 600. The assigned venture project 420 associated with a bigger numeric value of the evaluation 510 may be selected for further participation in the competition.

In some embodiments, the investment amount may be provided in a form of a voting ticket. The voting ticket may have a predetermined value, for example, one US dollar. Third persons may purchase voting tickets, transfer and/or exchange the voting tickets with each other. A venture capitalist may purchase a special voting ticket, called a venture capitalist voting ticket. The value of the venture capitalist voting ticket may be higher than the value of the voting tickets. For example, the venture capitalist voting ticket may be 100 times the value of a voting ticket. The venture capitalist voting tickets may be transferred or exchanged between the venture capitalists. The number of voting tickets may be fixed.

In some embodiments, the voting ticket or the venture capitalist voting ticket may be associated with an advertisement time slot. The advertisement time slot may be converted into investments and shares.

In some embodiments, the voting ticket or the venture capitalist voting ticket may be associated with a future venture project. Thus, audience may pre-order a product associated with the future venture project. In this case, the persons investing in the future venture project may obtain a specific discount, for example, 30 per cent.

Additionally, the venture capitalist may provide seed money, advice, and connections to a venture project. The provided seed money, advice, and connections may compose approximately 1% to 20% of equity of the venture project.

In some embodiments, the competitive investment raising may be made via crowd funding. Funds may be received through a television show, public demonstration, online broadcasting, and so forth.

For the competitive investment raising, a deadline and a minimum funding goal may be set for the competitive investment raising. If the minimum funding goal is not collected till the deadline, he competitive investment raising may be considered not fulfilled. If the competitive investment raising succeeds, a predefined amount or a percentage of the collected funds may be deducted by the system.

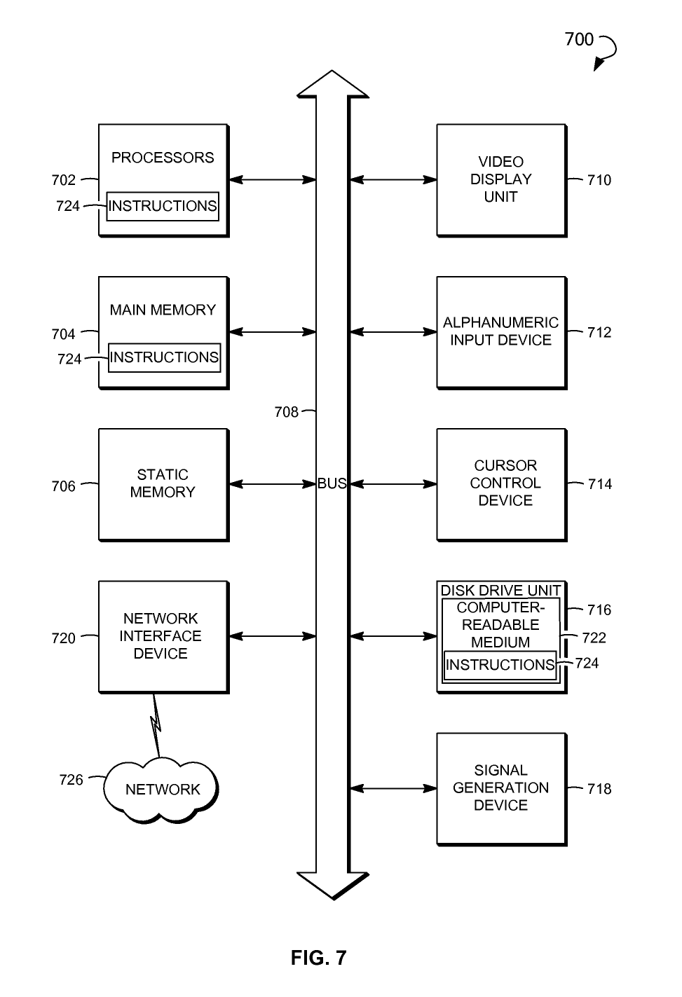

FIG. 7 is a diagrammatic representation of an example machine in the form of a computer system 700 within which a set of instructions for causing the machine to perform any one or more of the methodologies discussed herein is executed.

In various example embodiments, the machine operates as a standalone device or may be connected (e.g., networked) to other machines. The machine may include its own internal database or be connected to an external database in order to provide substantially real time updates. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 may also include an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a computer-readable medium 722, on which is stored one or more sets of instructions and data structures (e.g., instructions 724) embodying or utilized by any one or more of the methodologies or functions described herein. The instructions 724 may also reside, completely or at least partially, within the main memory 704 and/or within the processors 702 during execution thereof by the computer system 700. The main memory 704 and the processors 702 may also constitute machine-readable media.

The instructions 724 may further be transmitted or received over a network 726 via the network interface device 720 utilizing any one of a number of well-known transfer protocols (e.g., Hyper Text Transfer Protocol (HTTP)).

While the computer-readable medium 722 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein may be implemented in an operating environment comprising software installed on a computer, in hardware, or in a combination of software and hardware.

Thus, example embodiments of systems and methods for competitive investment raising for a venture project have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A method for competitive investment raising for a venture project, the method comprising:
receiving data on a number of venture projects;
assigning one or more of the number of venture projects to a venture capitalist, the venture project assigned to the venture capitalist being an assigned venture project;
providing a pre-investment amount to the assigned venture project;
periodically receiving a progress report from a representative of the assigned venture project;
periodically receiving an evaluation of the assigned venture project, the evaluation including one or more of the following: a venture capitalist opinion, an expert opinion, public votes;
based on the evaluation, periodically selecting one or more failed venture projects, a failed venture project dropping out of the competitive investment raising;
determining a winning venture project, the winning venture project receiving an investment amount.

2. The method of claim 1, wherein the number of venture projects is preselected by an organizer of the competitive investment raising.

3. The method of claim 1, wherein the venture project not assigned to the venture capitalist drops out of the competitive investment raising.

4. The method of claim 1, wherein the representative is a head of the venture project.

5. The method of claim 1, wherein the competitive investment raising is a television reality show.

6. The method of claim 1, wherein the competitive investment raising is an online service.

7. The method of claim 1, further comprising:
displaying a third party advertisement associated with the one or more of the following: the venture project, the assigned venture project, or the winning venture project, the competitive investment raising.

8. The method of claim 7, further comprising:
identifying an interaction level of one or more users with the third party advertisement while the one or more users interact with an online service for the competitive investment raising;
determining a fee payable by a third party based on the interaction level of the one or more users with the third party advertisement.

9. The method of claim 1, wherein the evaluation further includes media votes, the media votes comprising votes provided by a media representative, a newspaper, a magazine, an online media resource, a television channel, a radio channel.

10. The method of claim 1, wherein the venture capitalist mentors the assigned venture project associated with the venture capitalist.

11. The method of claim 1, wherein the investment amount is partially or fully provided by public, media, or a venture capitalist.

12. A system for competitive investment raising for a venture project, the system comprising:
a memory to store data on a number of venture projects;
a processor communicatively coupled to the memory and configured to:
receive the data on the number of venture projects;
assign one or more of the number of venture projects to a venture capitalist, the venture project assigned to the venture capitalist being an assigned venture project;
provide a pre-investment amount to the assigned venture project;
periodically receive a progress report from a representative of the assigned venture project;
periodically receive an evaluation of the assigned venture project, the evaluation including one or more of the following: a venture capitalist opinion, an expert opinion, public votes;
based on the evaluation, periodically select one or more failed venture projects, the failed venture project dropping out of the competitive investment raising;
determine a winning venture project, the winning venture project receiving an investment amount.

13. The system of claim 12, wherein the number of venture projects in preselected by an organizer of the competitive investment raising.

14. The system of claim 12, wherein the venture project not assigned to the venture capitalist drops out of the competitive investment raising.

15. The system of claim 12, wherein the competitive investment raising is a television reality show.

16. The system of claim 12, wherein the competitive investment raising is an online service.

17. The system of claim 12, wherein the processor is further configured to:
display a third party advertisement associated with the one or more of the following: the venture project, the assigned venture project, the winning venture project, the competitive investment raising;
identify an interaction level of one or more users with the third party advertisement while the one or more users interacts with an online service for the competitive investment raising;
determine a fee payable by a third party based on the interaction level of the one or more users with the third party advertisement.

18. The system of claim 12, wherein the evaluation further includes media votes, the media votes comprising votes provided by a media representative, a newspaper, a magazine, an online media resource, a television channel, a radio channel.

19. The system of claim 12, wherein the investment amount is partially or fully provided by public, media, or the venture capitalist.

20. The system of claim 12, wherein the investment amount is provided in a form of a voting ticket, the voting ticket having a predetermined value.

21. The system of claim 20, wherein a number of the voting tickets is fixed, and the voting tickets are transferred or exchanged between third parties.

22. The system of claim 20, wherein a venture capitalist voting ticket is provided for the venture capitalist, wherein the venture capitalist voting ticket has a value representing a predefined number of the voting tickets, the venture capitalist voting tickets being transferred or exchanged between the venture capitalists.

23. The system of claim 22, wherein the voting ticket or the venture capitalist voting ticket is associated with an advertisement time slot.

24. The system of claim 22, wherein the voting ticket or the venture capitalist voting ticket is associated with a future venture project.

25. The system of claim 12, wherein a predetermined commission is extracted from the investment amount of the winning venture project.

26. The system of claim 12, wherein funds associated with the failed venture projects are returned to after deduction of a predefined amount.

27. The system of claim 12, wherein the venture capitalist provides seed money, advice, and connections, the seed money, advice, and connections composing approximately 1% to 20% of equity of the venture project.

28. The system of claim 12, wherein the competitive investment raising is made via crowd funding through a television show, public demonstration, and online broadcasting.

29. The system of claim 12, wherein a deadline and a minimum funding goal are set for the competitive investment raising, wherein the competitive investment raising is considered not fulfilled, if the minimum funding goal is not collected until the deadline.

30. A computer-readable medium comprising instructions, which when executed by one or more processors, perform the following operations:
receive data on a number of venture projects;
assign one or more of the number of venture projects to a venture capitalist, the venture project assigned to the venture capitalist being an assigned venture project;
provide a pre-investment amount to the assigned venture project;
periodically receive a progress report from a representative of the assigned venture project;
periodically receive an evaluation of the assigned venture project, the evaluation including one or more of the following: a venture capitalist opinion, an expert opinion, public votes;
based on the evaluation, periodically select one or more failed venture projects, the failed venture project dropping out of the competitive investment raising;
determine a winning venture project, the winning venture project receiving an investment amount.
